(19) United States
(12) Patent Application Publication
(10) Pub. No.: US 2011/0121242 A1
(43) Pub. Date: May 26, 2011

(54) MASTERBATCH FOR ELECTROCONDUCTIVE THERMOPLASTIC POLYMER, PROCESS TO PREPARE SUCH MASTERBATCH, AND THE USE THEREOF

(75) Inventor: Robert Alex De Gunst, Deventer (NL)

(73) Assignee: AKZO NOBEL N.V, Arnhem (NL)

(21) Appl. No.: 13/055,540

(22) PCT Filed: Jul. 21, 2009
(86) PCT No.: PCT/EP2009/059325

§ 371 Date: Jan. 24, 2011

Related U.S. Application Data
(60) Provisional application No. 61/086,548, filed on Aug. 6, 2008.

(30) Foreign Application Priority Data
Jul. 24, 2008 (EP) 08161106.3

(51) Int. Cl. H01B 1/24

(52) U.S. Cl. 252/511

(57) ABSTRACT

The present invention provides a process to prepare a masterbatch comprising more than 0 wt % and up to 70 wt % carbon black with a DBP absorption of at least 200 ml/100 g and a thermoplastic polymer and, optionally, further additives, comprising the steps of mixing in random order successively or simultaneously, at an elevated temperature, a liquid medium, carbon black, and thermoplastic polymer, and, optionally, the additives, wherein the liquid medium is ultimately present in an amount of more than 0 wt % and up to 80 wt % on the total weight of carbon black and thermoplastic polymer; subsequently cooling and pelletizing the composition; separating off the liquid medium by extraction with a solvent; and drying the composition. Additionally provided are a masterbatch suitable for preparing an electroconductive thermoplastic polymer composition and a process to prepare an electroconductive thermoplastic polymer composition.

The present invention relates to a masterbatch for an electroconductive thermoplastic polymer, to a process to prepare such masterbatch, and to the use thereof. More specifically, the invention relates to a masterbatch containing a high amount of electroconductive carbon black and a thermoplastic polymer, a process to prepare it, and the use thereof.

In a number of applications it is desired to give thermoplastic polymer compositions good electroconductive properties. One example thereof is the automobile industry, where it is desired that the plastic parts of the vehicle are electroconductive like the metal parts, so that the complete vehicle can be provided with a powder coating layer in a single step.

To give a thermoplastic polymer composition electroconductive properties, small particles can be added thereto such as, for example, carbon black particles that have a relatively high porosity.

There is a desire in the industry to have masterbatches of carbon black and the thermoplastic polymer. Such masterbatches contain a relative high amount of carbon black particles and can be simply diluted with thermoplastic polymer by the end user to make the desired electroconductive thermoplastic polymer composition. The use of masterbatches thus makes the carbon black easier to handle and enables easy dosing and uniform and rapid dispersion of the carbon black in the polymer without dusting.

Masterbatches known so far are generally prepared by melt mixing the components with the aid of extruders.

JP 07011064 discloses the preparation of an electroconductive polyolefin masterbatch by kneading conductive carbon black and polyolefin thermoplastics above the melting temperature of the resin and moulding after cooling. The amount of carbon black that can be introduced into the polyolefin by this method is said to be between 15 and 40 wt %; however, in the examples the highest content achieved is 30 wt %.

However, carbon black particles with a high porosity cannot simply be added to a thermoplastic polymer in a high dose, as the carbon black addition will result in a too viscous or even dry (dusty) thermoplastic polymer composition. Also sticking of the carbon black particles might occur, which makes a uniform dispersion of the particles through the polymer matrix impossible.

JP 2002322366 discloses a process to make an electroconductive thermoplastic polymer by the addition of carbon black thereto. The process encompasses the step of adding a carboxylic acid additive to the carbon black in a low amount so that the carbon black is coated with a carboxylic acid, and subsequently melt kneading the coated carbon black with the thermoplastic polymer. Compositions containing amounts of carbon black of up to 18 wt % are prepared in the examples using isophthalic acid as the carboxylic acid additive.

The invention now provides a process to prepare a masterbatch comprising up to 70 wt % carbon black with a DBP absorption of at least 200 ml/100 g and a thermoplastic polymer and, optionally, further additives, comprising the steps of
mixing in random order successively or simultaneously, at an elevated temperature, a liquid medium, carbon black, and thermoplastic polymer, and, optionally, the additives, wherein the liquid medium is ultimately present in an amount of more than 0 wt % and up to 80 wt % on the total weight of carbon black and thermoplastic polymer;
subsequently cooling and pelletizing the composition;
separating off the liquid medium by extraction with a solvent;
drying the composition.

Additionally, the invention provides a masterbatch obtainable by the above process.

The masterbatch obtainable by the process of the invention was found to have characteristics different from those of masterbatches prepared by state of the art melt kneading processes such as disclosed by JP 07011064. Thus the masterbatch was found to be better dispersible in thermoplastic polymer, easier to handle (lower dust content), and less friable.

The present invention moreover provides a masterbatch suitable for preparing an electroconductive thermoplastic polymer composition, comprising 40-70 wt % of carbon black with a DBP absorption of at least 200 ml/100 g and 60-30 wt % of a thermoplastic polymer and, optionally, further additives.

Finally, the invention provides a process to prepare electroconductive thermoplastic polymer compositions comprising the steps of making a masterbatch in accordance with the above process and subsequently mixing this masterbatch with thermoplastic polymer.

By pelletizing is meant each method to make particulate material of the composition, including several methods such as extruding, milling, or cutting the composition. It is understood that a number of pelletizing methods take place at an elevated temperature.

DBP absorption is a value for the porosity of the carbon black and stands for the dibutyl phthalate oil absorption in accordance with ASTM D2414.

Due to a regular pellet shape and lower friability of the pellet easy dosing of the masterbatch to thermoplastic polymer is achieved.

The liquid medium is used at least in an amount such that after the incorporation of the carbon black into the masterbatch practically all carbon black particles are entirely surrounded by the liquid medium and the polymer. In general the liquid medium is used in an amount of more than 0 wt % and up to 80 wt %, based on the amount of the total composition, preferably 10-70 wt %, even more preferably 20-70 wt %. The liquid medium should be able to withstand the melting point of the thermoplastic polymer which means that in general it should have a boiling point of above 180° C., preferably above 200° C., more preferably above 250° C., and should be easily separable from the thermoplastic polymer by extraction with a solvent. Additionally, the liquid medium should not be such that the thermoplastic polymer dissolves or swells therein at ambient temperature.

Suitable examples of the liquid medium are not limited to phthalates such as di-C₁-C_{10—}alkyl-phthalates like dimethyl, dibutyl, dioctyl, diisobutyl, diisononyl phthalate, butylbenzyl and polyglycol phthalate, amines such as (ethoxylated) fatty acid amines, amides such as (ethoxylated) fatty acid amides, triethyl phosphate, tricresyl phosphate, acetyltributyl citrate, dioctyl adipate, epoxidized soybean oil and glycols, like ethylene glycol, diethylene glycol, triethylene glycol, polyethylene glycols, propylene glycol, dipropylene glycol, tripropylene and polypropylene glycol, 1,3-propanediol, 1,4-butanediol, 2,3-butanediol, hexylene glycol, 1,5-pentanediol, glycerol, monoethers, diether and esters of glycols, C8-C12 alcohols, paraffins, soybean oil .

In general, besides being mixable with the liquid medium, the solvent used for extraction should be relatively volatile, i.e. have a boiling point of below 100° C., nor should the thermoplastic polymer be soluble or swellable in this solvent. Suitable examples of the extraction solvent are C₁-C₈ alkanes like pentane, hexane, heptane, chlorinated alkanes like chloroform, dichloromethane, ketones such as acetone, methylethylketone.

It was found that by using the above process instead of adhering to the teaching of the prior art it is possible to make masterbatches containing a substantially higher carbon black content and amounts of up to 70 wt % (on the basis of total amount of carbon black and thermoplastic polymer) can be easily obtained. In a preferred embodiment the amount of carbon black is 40-60 wt %

In a preferred embodiment the solvent and liquid medium are chosen such that they can be easily separated from one another and therefore are reusable.

Methods to separate the solvent and the liquid medium from one another are known to a person skilled in the art and include distillation, decantation, liquid layer separation. In another embodiment a liquid medium can be used that solidifies at a lower temperature and therefore can be separated off from the solvent as a solid by e.g. filtration.

Additives that may be added to the masterbatch or to the thermoplastic polymer composition include but are not limited to antioxidants, antiozonants, antidegradants, UV-stabilizers, coagents, antifungicides, antistats, pigments, dyes, coupling agents, dispersing aids, blowing agents, lubricants, process oils, fillers, reinforcing agents.

The carbon black of the present invention in a preferred embodiment has a DBP absorption of above 250 ml/100 g, even more preferred above 300 ml/100 g.

Preferred examples of the carbon black are Ketjenblack EC300J and Ketjenblack EC600JD.

### EXAMPLES

### (Comparative) Preparation Examples 1-7

### Example 1

10 g of carbon black (Ketjenblack EC600JD, having a DBP absorption of 550 ml/100 g) and 10 g of polypropylene (HC101 BF ex Borealis) were mixed in the presence of 50 g of erucamide (Armoslip E ex Akzo Nobel). The mixture was processed at a temperature of 250° C. in a mixing chamber in a comparable manner to the processing of pure polypropylene (as known to skilled persons). After cooling the mixture to room temperature the solid material was milled into 1 mm particles and the erucamide was extracted with boiling n-heptane. Subsequently, the composition was dried 30 minutes at 110° C. and a high vacuum was applied to evaporate remaining traces of the extraction solvent. The composition of the resulting particles was calculated, based on weight, to contain 48 wt % of carbon black, 48 wt % of polypropylene, and 4 wt % of erucamide.

### Comparative Example 2

Example 1 was repeated without the addition of erucamide. The resulting mixture could not be processed at 250° C., as it was too dry and dusty.

### Example 3

Example 1 was repeated but instead of erucamide, soybean oil (ex Lidl supermarket) was used. The resulting particles were calculated to contain 47.5 wt % carbon black, 47.5 wt % polypropylene, and 5 wt % soybean oil.

### Example 4

10 g of carbon black (Ketjenblack EC600JD), 20 g of polyamide 6 (Akulon F223-D ex DSM) were mixed in the presence of 50 g of erucamide (Armoslip E ex Akzo Nobel). The mixture was processed at a temperature of 250° C. in a mixing chamber in a comparable manner to the processing of pure polyamide. After cooling the mixture to room temperature the solid material was milled into 1 mm particles and the erucamide was extracted with boiling n-heptane. Subsequently the composition was dried 30 minutes at 110° C. and a high vacuum was applied to evaporate remaining traces of the extraction solvent. The resulting particles were calculated to contain 30 wt % of carbon black, 60 wt % of polyamide, and 10 wt % of erucamide.

### Example 5

Example 4 was repeated with 10 g of polyamide instead of 20 g. Particles could be made that contained 45 wt % of carbon black, 45 wt % of polyamide, and 10 wt % of erucamide.

### Example 6

10 g carbon black (Chezacarb A+ ex Chempetrol) having a porosity of 360 ml/g and 30 g PP (Moplen HP500N ex Basell) were mixed with 20 g diisodecyl phtalate (DIDP) in a Haake Miniextruder type CTW5 (temperature 250° C. and at 100 rpm.) After cooling down, the solid material was milled into 1 mm particles and extracted with boiling dichloromethane. The resulting particles were calculated to contain 24 wt % of carbon black, 73 wt % of PP, and 3 wt % DIDP.

### Example 7

Example 6 was repeated with 10 g of DIDP instead of 20 g.

The resulting particles were calculated to contain 24 wt % of carbon black, 73 wt % of PP, and 3 wt % DIDP.

### (Comparative) Application Examples I-IV

### Example I (use of masterbatch to prepare polymer article)

The masterbatch of Example 1 was used to make a conductive polypropylene article. The masterbatch was diluted with polypropylene (Moplen HP500N ex Basell) until it contained 3 wt % of carbon black using a Haake mixing chamber operating at 50 rpm for 30 minutes at 230° C. The resulting polypropylene polymer was pressed into 2 mm sheets at 190° C. by compression moulding and the resistivity thereof was measured in accordance with ASTM D257. The results are given in Table 1.

### Comparative Example II

A conductive polypropylene article of the same composition as in Example I was made using pure carbon black (Ketjenblack EC600JD) instead of the masterbatch of Example 1.

### Example III

The sample obtained in Example 6 was diluted in Moplen HP500N ex Basell to contain 5 wt % of carbon black using a Haake mixing chamber operating at 50 rpm for 30 minutes at 230° C. The resulting polymer was pressed into 2 mm sheets at 190° C. by compression moulding and the resistivity of the resulting article was measured in accordance with ASTM D257. The results are given in Table 1.

### Comparative Example IV

A conductive polypropylene article of the same composition as in Example III was made using pure carbon black (Chezacarb A+) instead of the masterbatch of Example 6.

TABLE 1
(resistivity in Ohm · cm. Measurement in accordance with ASTM D257)

| | | Addition % pure | Resistivity in |
|---|---|---|---|
| | Carbon black | carbon black | Ohm · cm |
| Example I | Masterbatch of Ex 1 | 3 | 1520 |
| Comparative | Pure carbon black | 3 | 200 |
| Example II | | | |
| Example III | Masterbatch of Ex 6 | 5 | 310 |
| Comparative | Pure carbon black | 5 | 200 |
| Example IV | | | |

In the above Table it can be seen that compared to the resistivity of pure polypropylene, which lies in the order of 10¹⁴-10¹⁵ Ohm.cm, electroconductive polypropylene having the same beneficial conductive properties can be prepared by both using the masterbatch of the present invention and pure carbon black.

1. A process to prepare a masterbatch comprising more than 0 wt % and up to 70 wt % carbon black with a DBP absorption of at least 200 ml/100 g and a thermoplastic polymer, comprising the steps of
mixing in random order successively or simultaneously, at an elevated temperature, a liquid medium, the carbon black, and the thermoplastic polymer to form a composition, wherein the liquid medium is ultimately present in an amount of more than 0 wt % and up to 80 wt % of the total weight of the carbon black and the thermoplastic polymer;
subsequently cooling and pelletizing the composition;
separating off the liquid medium by extraction with a solvent; and
drying the composition.

2. The process according to claim 1 wherein the solvent and the liquid medium are chosen such that they can be easily separated from one another.

3. The process according to claim 2 wherein the solvent and/or the liquid medium are reused.

4. A process to prepare electroconductive thermoplastic polymer compositions comprising the steps of making a masterbatch in accordance with the process of claim 1 and subsequently mixing the masterbatch with the thermoplastic polymer.

5. A masterbatch obtained by the process according to claim 1.

6. A masterbatch suitable for preparing an electroconductive thermoplastic polymer composition, the masterbatch comprising 40-70 wt % of carbon black with a DBP absorption of at least 200 ml/100 g and 60-30 wt % of a thermoplastic polymer.

7. A process to prepare electroconductive thermoplastic polymer compositions comprising the steps of making a masterbatch in accordance with the process of claim 2 and subsequently mixing the masterbatch with the thermoplastic polymer.

8. A process to prepare electroconductive thermoplastic polymer compositions comprising the steps of making a masterbatch in accordance with the process of claim 3 and subsequently mixing the masterbatch with the thermoplastic polymer.

9. A masterbatch obtained by the process according to claim 2.

10. A masterbatch obtained by the process according to claim 3.

11. The masterbatch according to claim 6 further comprising additives.

12. The process according to claim 1 wherein the masterbatch further comprises additives, and wherein the additives are included in the mixing step.

13. The process according to claim 12 wherein the solvent and the liquid medium are chosen such that they can be easily separated from one another.

14. The process according to claim 13 wherein the solvent and/or the liquid medium are reused.

15. A process to prepare electroconductive thermoplastic polymer compositions comprising the steps of making a masterbatch in accordance with the process of claim 12 and subsequently mixing the masterbatch with the thermoplastic polymer.

16. A masterbatch obtained by the process according to claim 12.

17. The masterbatch according to claim 11, wherein the additives are selected from the group consisting of antioxidants, antiozonants, antidegradants, UV-stabilizers, coagents, antifungicides, antistats, pigments, dyes, coupling agents, dispersing aids, blowing agents, lubricants, process oils, fillers and reinforcing agents.

18. The process according to claim 12, wherein the additives are selected from the group consisting of antioxidants, antiozonants, antidegradants, UV-stabilizers, coagents, antifungicides, antistats, pigments, dyes, coupling agents, dispersing aids, blowing agents, lubricants, process oils, fillers and reinforcing agents.

19. The process according to claim 13, wherein the additives are selected from the group consisting of antioxidants, antiozonants, antidegradants, UV-stabilizers, coagents, antifungicides, antistats, pigments, dyes, coupling agents, dispersing aids, blowing agents, lubricants, process oils, fillers and reinforcing agents.
